(19) United States
(12) Patent Application Publication
(10) Pub. No.: US 2017/0254128 A1
(43) Pub. Date: Sep. 7, 2017

(54) Hinge Used For Furniture

(71) Applicant: GUANGDONG TAIMING METAL PRODUCTS CO. LTD, Foshan City (CN)

(72) Inventor: Tai Wai NG, Foshan City (CN)

(73) Assignee: GUANGDONG TAIMING METAL PRODUCTS CO. LTD, Foshan City (CN)

(21) Appl. No.: 15/148,458

(22) Filed: May 6, 2016

(30) Foreign Application Priority Data
Mar. 7, 2016 (CN) 201610129007.2

(51) Int. Cl. E05D 5/06; E05F 3/20; E05D 3/02

(52) U.S. Cl. CPC E05D 5/065; E05D 3/02; E05F 3/20

(57) ABSTRACT

A hinge used for furniture, including a movable cup seat, an adjustable cover plate, a hinging arm connected between the movable cup seat and the adjustable cover plate as well as torsion springs, wherein two torsion springs are respectively arranged on the notches on both sides of the movable cup seat; the torsion springs are provided with at least a first support leg linked to the protruded steps on both sides of the movable cup seat and a second support leg that extends into the movable cup seat capable of acting force on the hinging arm; the first support leg and/or the second support leg has a square-shaped section; the second support leg is provided with a torsion spring sleeve so that the second support leg is inserted into the corresponding sleeve holes.

### TECHNICAL FIELD

The present utility model relates to a hinge used for furniture

### BACKGROUND

On Oct. 1, 2014, Chinese patent (patent number: CN203856309U) disclosed a silencing hinge for furniture, and specifically disclosed that the silencing hinge for furniture comprises a movable hinge cup connected with a door panel, a fixed part connected with a wall panel, and a hinging arm used for connecting the movable hinge cup with the fixed part, wherein a damper is arranged on the movable hinge cup and acts on the hinging arm at least when the hinge is closed, a spring which at least applies opening and closing acting force to the movable hinge cup is arranged in the hinge, and one end of the hinging arm is hinged to the movable hinge cup through a connecting unit; the cross section of at least one end of the spring is not circular, a sliding part is arranged on the non-circular cross section of the spring, a cavity is formed in the sliding part, at least one end of the spring is arranged in the cavity, and the bottom surface of the sliding part acts on a rotary part of the hinging arm under the elastic action of the spring, moves relative to the rotary part when the hinge is opened and/or closed. However, such structure is unstable in sliding performance. Therefore, it is necessary to make further improvement.

### DESCRIPTION

The objective of the present utility model is to provide a hinge for furniture which is featured by simple and reasonable structure, simplified assembly work procedures and manufacturing process, low production cost, and good practicability, so as to overcome the deficiencies in the prior art.

A hinge used for furniture which is designed according to this objective, comprising a movable cup seat fixed on the furniture door body, an adjustable cover plate fixed on the furniture main body, a hinging arm connected between the movable cup seat and the adjustable cover plate as well as torsion springs configured to generate opening force or closing force at least on the movable cup seat, wherein two torsion springs are respectively arranged on the notches on both sides of the movable cup seat, characterized in that the torsion springs are provided with at least a first support leg linked to the protruded steps on both sides of the movable cup seat and a second support leg that extends into the movable cup seat capable of acting force on the hinging arm; the first support leg and/or the second support leg has a square-shaped section; the second support leg is provided with a torsion spring sleeve so that the second support leg is inserted into the corresponding sleeve holes; the torsion spring sleeve has a square outline, the bottom of which relatively moves along the arc-shaped stressed portion on the two sides of the hinging arm under the force applied by the torsion spring, thus generating opening force or closing force.

The second support leg has a straightly-arranged square section, the sleeve holes are arranged in a manner of penetrating the torsion spring sleeve along the length direction, the section of the sleeve holes is squarely arranged corresponding to the second support leg, and the second support leg is correspondingly inserted into the sleeve holes.

One end of torsion spring sleeve near the main body of the torsion springs is provided with an arc-shaped surface matching the main body surface of the torsion springs.

One side of the arc-shaped surface is extended along the length direction and is provided with a protruded point, and the protruded point is inserted into the main body of the torsion springs.

The parts of the torsion spring sleeve configured to insert into the second support leg are thickened.

The end portion of the first support leg is bent and is reversely buckled into the steps.

The movable cup seat is internally provided with a slot position, one end portion of the hinging arm is inserted into the slot position and is hinged with the movable cup seat through axis pins, the second support leg is inserted into the slot position and is configured to act on the stressed portion after passing through the side wall of the notches.

The slot position is internally provided with a damper, one side or two sides on the inner wall of the slot position is/are provided with a positioning buckle, the corresponding one side or two sides of the damper is/are protruded externally and buckled below the positioning buckle, the top of one end of the damper is leaned against the inner wall of the slot position and the top of other end of the damper is leaned against the hinging arm to buffer the opening force and closing force of the hinging arm.

The two sides of the other end portion of the hinging arm are provided with slide sheets, the adjustable cover plate is provided with a slide slot, the slide sheets can be freely inserted into the slide slot in a sliding manner, the hinging arm is capable of sliding freely with respect to the adjustable cover plate, the hinging arm is further provided with a capsule-shaped regulating hole, and an eccentric screw passes through the regulating hole to be screwed on the adjustable cover plate.

The torsion spring sleeve is formed by integrated plastic injection, and the two torsion springs are coaxially arranged with each other.

By arranging a torsion spring sleeve to insert the second support leg of the torsion spring, thus the torsion spring of the present utility model can be directly assembled onto the movable cup seat without any auxiliary parts, thus the assembly work procedures and the manufacturing process are simplified, meanwhile, the production cost is further reduced, and the practicability is good. Both the second support leg and the sleeve hole are squarely arranged to ensure a more stable structure, and arranging a square outline for the torsion spring is able to prevent deflection and displacement. Configuring the arc-shaped surface to match the main body surface of the torsion spring ensures s more compact structure. And configuring the protruded point to insert into the main body of the torsion spring can effectively prevent the torsion spring sleeve being loosened and separated. The present utility model is featured by simple and reasonable structure, simplified assembly procedures and manufacturing process, low manufacturing cost and good practicability.

### DESCRIPTION OF DRAWINGS

FIG. 1 is the breakdown structure diagram of the first embodiment of the present utility model.

FIG. 2 is the assembly structure diagram of the first embodiment of the present utility model.

FIG. 3 is the structure diagram of the movable cup seat in the first embodiment of the present utility model.

FIG. 4 is the breakdown structure diagram of movable cup seat and the torsion spring in the first embodiment of the present utility model.

FIG. 5 is the assembly structure diagram of the movable cup seat, the hinging arm and the torsion spring in the first embodiment of the present utility model.

FIG. 6 is the breakdown structure diagram of the hinging arm and the adjustable cover plate in the first embodiment of the present utility model.

FIG. 7 is the assembly structure diagram of the hinging arm and the adjustable cover plate in the first embodiment of the present utility model.

FIG. 8 is the breakdown structure diagram of the adjustable cover plate and the fixed part in the first embodiment of the present utility model.

FIG. 9 is the assembly structure diagram of the adjustable cover plate and the fixed part in the first embodiment of the present utility model.

FIG. 10 is the breakdown structure diagram of the torsion spring and the torsion spring sleeve in the first embodiment of the present utility model.

FIGS. 11 and 12 are respectively the assembly structure diagrams of the torsion spring and the torsion spring sleeve in the first embodiment of the present utility model.

FIG. 13 is the side view of the torsion spring sleeve in the first embodiment of the present utility model.

FIG. 14 is the cutaway view in A-A direction of the first embodiment of the present utility model.

FIG. 15 is the cutaway view in A-A direction of the second embodiment of the present utility model

FIG. 16 is breakdown structure diagram of the third embodiment of the present utility model.

FIG. 17 is assembly structure diagram of the third embodiment of the present utility model.

FIG. 18 is breakdown structure diagram of the fourth embodiment of the present utility model.

FIG. 19 is assembly structure diagram of the fourth embodiment of the present utility model.

FIG. 20 is breakdown structure diagram of the fifth embodiment of the present utility model.

FIG. 21 is assembly structure diagram of the fifth embodiment of the present utility model.

FIG. 22 is assembly structure diagram of the sixth embodiment of the present utility model.

### DETAILED DESCRIPTION OF EMBODIMENTS

The present utility model is further described in combination with attached drawings and embodiments.

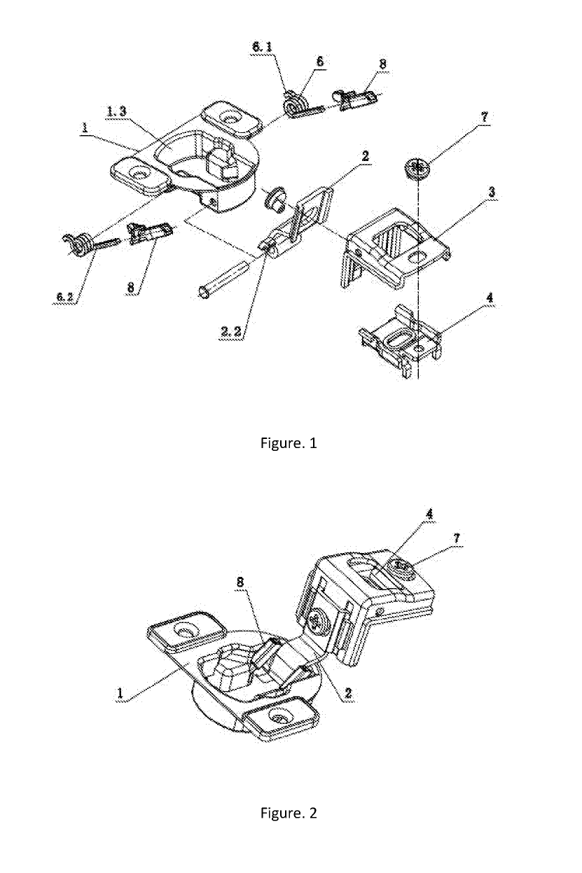

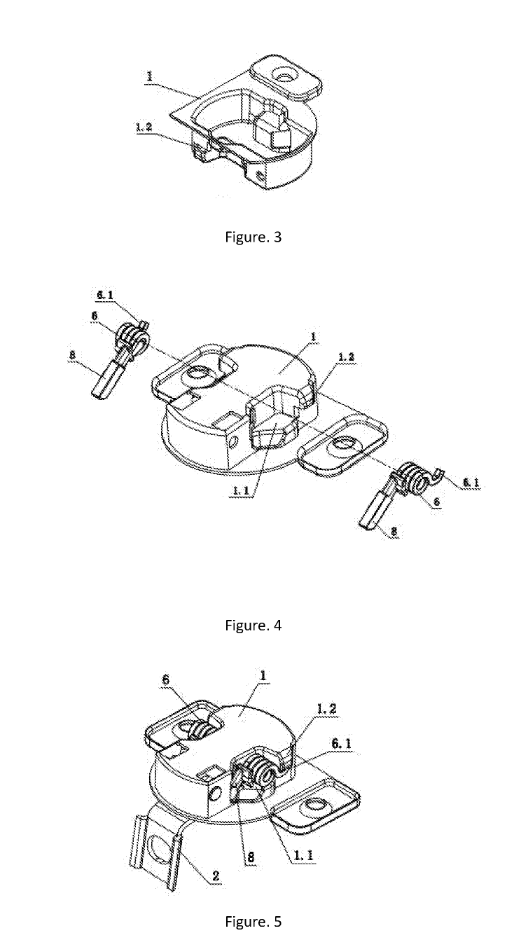

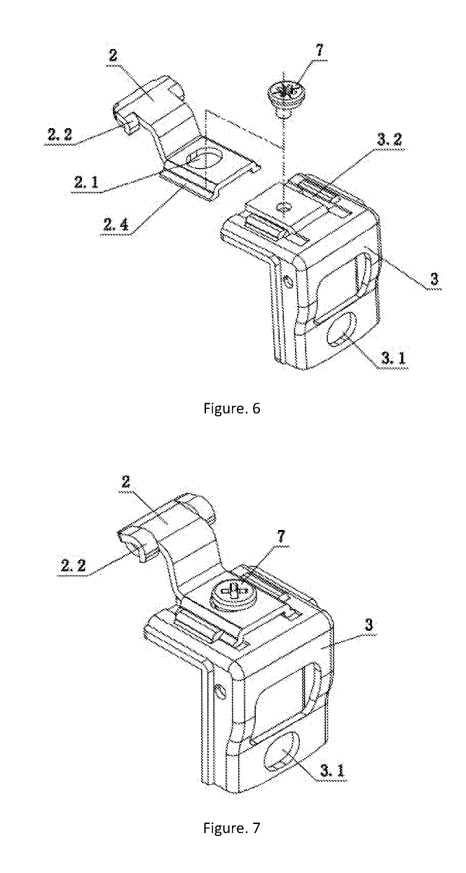

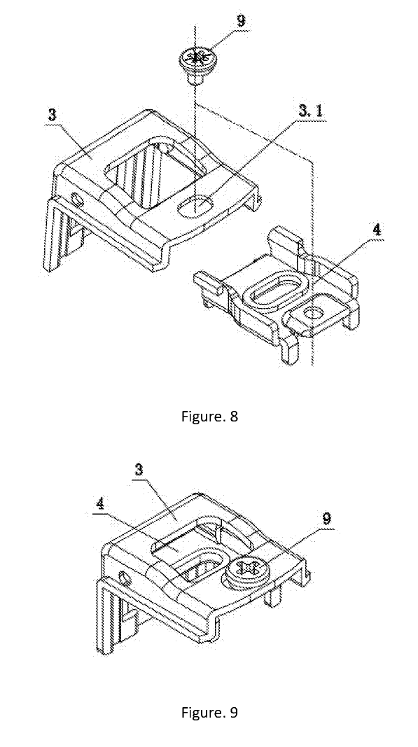

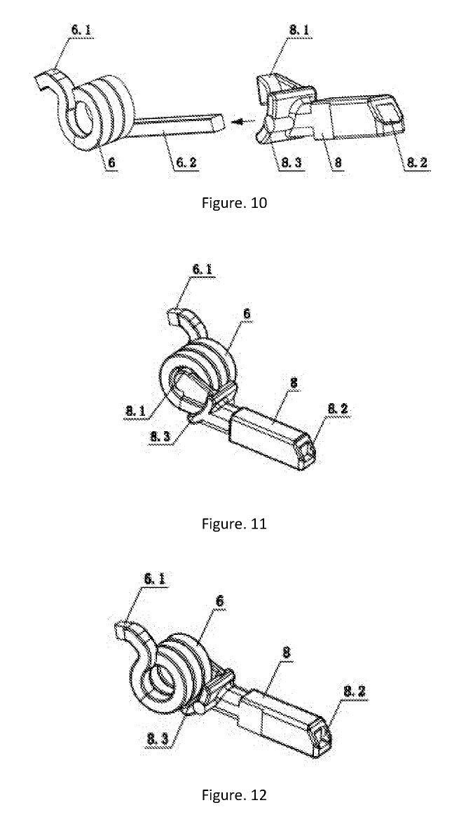

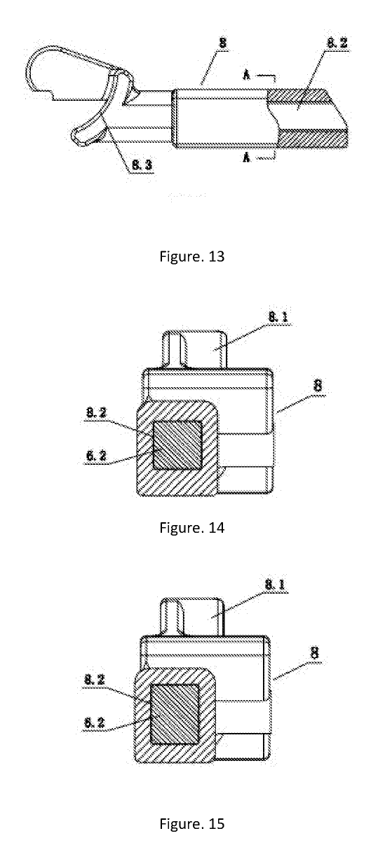

### The First Embodiment (with Reference to FIGS. 1-14)

A hinge used for furniture, comprising a movable cup seat 1 fixed on the furniture door body, an adjustable cover plate 3 fixed on the furniture main body, a hinging arm 2 connected between the movable cup seat 1 and the adjustable cover plate 3 as well as torsion springs 6 configured to generate opening force or closing force at least on the movable cup seat 1, wherein two torsion springs 6 are respectively arranged on the notches 1.1 on both sides of the movable cup seat 1, the torsion springs 6 are provided with at least a first support leg 6.1 linked to the protruded steps 1.2 on both sides of the movable cup seat 1 and a second support leg 6.2 that extends into the movable cup seat 1 capable of acting force on the hinging arm 2; the first support leg 6.1 and the second support leg 6.2 have a square-shaped section; the second support leg 6.2 is provided with a torsion spring sleeve 8 so that the second support leg 6.2 is inserted into the corresponding sleeve holes 8.2; the torsion spring sleeve 8 has a square outline, the bottom of which relatively moves along the arc-shaped stressed portion 2.2 on the two sides of the hinging arm 2 under the force applied by the torsion spring 6, thus generating opening force or closing force so as to assist opening or closing the door body. With the above-mentioned structure, the torsion springs can be directly assembled on the movable cup seat 1 without any auxiliary parts, thus the assembly work procedures and the manufacturing process are simplified, meanwhile, the production cost is further reduced, and the practicability is high. Specifically, the second support leg 6.2 has a straightly-arranged square section, the sleeve holes 8.2 are arranged in a manner of penetrating the torsion spring sleeve 8 along the length direction, the section of the sleeve holes 8.2 is squarely arranged corresponding to the second support leg 6.2, and the second support leg 6.2 is correspondingly inserted into the sleeve holes 8.2. The square sections of the second support leg 6.2 and the sleeve holes 8.2 are mutually fit to prevent the rotation of each other, thus further improving the stability.

One end of torsion spring sleeve 8 near the torsion springs 6 is provided with an arc-shaped surface 8.3 matching the main body surface of the torsion springs 6. Such arrangement ensures a more compact overall structure.

One side of the arc-shaped surface 8.3 is extended along the length direction and is provided with a protruded point 8.1, and the protruded point 8.1 is inserted into the torsion springs 6 to prevent the torsion spring sleeve 8 from being loosened and separated.

The parts of the torsion spring sleeve 8 configured to insert into the second support leg 6.2 are thickened, thus the durability is enhanced and meanwhile the torsion spring sleeve 8 cannot be deformed easily.

The end portion of the first support leg 6.1 is bent and is reversely buckled into the steps 1.2 so that the displacement or separation of the torsion spring 6 can be prevented effectively.

The movable cup seat 1 is internally provided with a slot position 1.3, one end portion of the hinging arm 2 is inserted into the slot position 1.3 and is hinged with the movable cup seat 1 through axis pins, the second support leg 6.2 is inserted into the slot position 1.3 and is configured to act on the stressed portion 2.2 after passing through the side wall of the notches 1.1 so that the elasticity of the torsion spring 6 can be applied on the hinging arm 2 through the torsion spring sleeve 8, thus providing opening force or closing force.

The two sides of the other end portion of the hinging arm 2 are provided with slide sheets 2.4, the adjustable cover plate 3 is provided with a slide slot 3.2, the slide sheets 2.4 can be freely inserted into the slide slot 3.2 in a sliding manner, the hinging arm 2 is capable of freely sliding in forward direction and backward direction with respect to the adjustable cover plate 3, the hinging arm 2 is further provided with a capsule-shaped regulating hole 2.1, and an eccentric screw 7 passes through the regulating hole 2.1 to be screwed on the adjustable cover plate 3. The structure further comprises a fixed part 4, thus the adjustable cover plate 3 can be adjustably fixed on the main body of furniture through the fixed part 4; the adjustable cover plate 3 matches up the fixed part 4 forward and backward in a sliding manner; and the other end of the adjustable cover plate 3 is provided with a capsule-shaped regulating hole 3.1, and an eccentric screw 9 passes through the regulating hole 3.1 to be screwed on the fixed part. Adjusting effect can be reached by using tools to apply force on the eccentric screw 9. And adjusting function can be realized by using tools to apply force on the eccentric screws 7 and 9.

The torsion spring sleeve 8 is formed by integrated plastic injection, and the two torsion springs 6 are coaxially arranged with each other.

### The Second Embodiment (with Reference to FIG. 15)

The hinge used for furniture differs from the first embodiment in the following aspects: the section of the second support leg 6.2 is rectangle-arranged corresponding to the sleeve holes 8.2, thus further improving the stability of the structure.

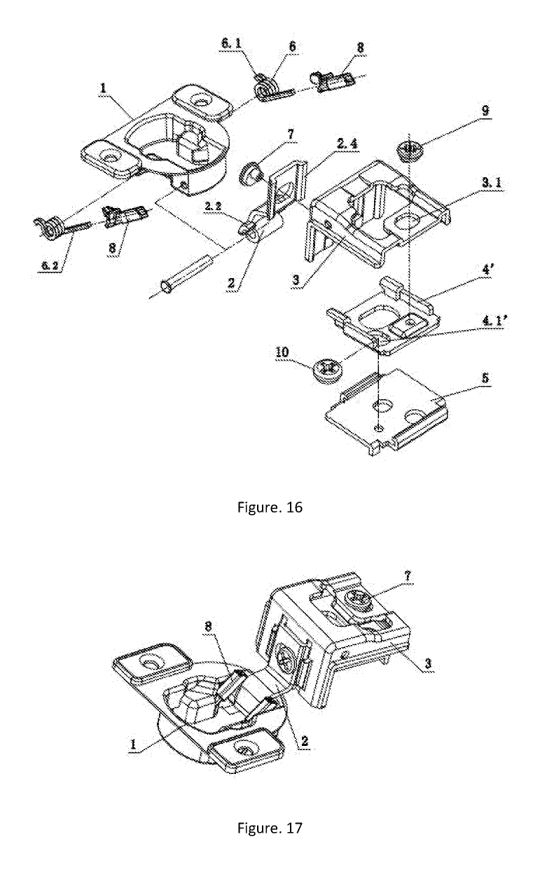

### The Third Embodiment (with Reference to FIG. 16 and FIG. 17)

The hinge used for furniture differs from the first embodiment in the following aspects: the structure comprises a movable cup seat 1, a hinging arm 2, an adjustable cover plate 3, a movable plate 4′ and a connecting plate 5, wherein the adjustable cover plate 3 is in sliding fit with the movable plate 4′ frontward and backward, the eccentric screw 9 passes through the capsule-shaped regulating hole 3.1 of the adjustable cover plate 3 to be screwed on the movable plate 4′; the movable plate 4′ is in sliding fit with the connecting plate 5 leftward and rightward, and the movable plate 4′ is provided with a capsule-shaped regulating hole 4.1′, the eccentric screw 10 passes through the capsule-shaped regulating hole 4.1′ to be screwed on the connecting plate 5; the connecting plate 5 is fixed on the furniture, the hinge is assembled on the furniture through the connecting plate 5; and the position of the hinge is adjusted by using tools to separately apply force on the eccentric screws 7, 9 and 10.

Other unmentioned contents of this embodiment are as same as those in the first embodiment, which are not analyzed and illustrated here again.

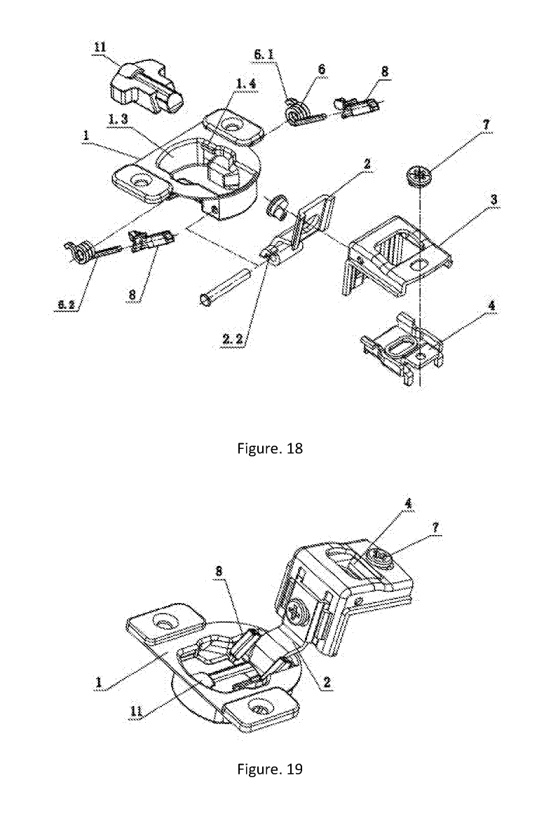

### The Fourth Embodiment (with Reference to FIG. 18 and FIG. 19)

The hinge used for furniture differs from the first embodiment in the following aspects: the slot position 1.3 is internally provided with a damper 11, the two sides on the inner wall of the slot position 1.3 are provided with a positioning buckle 1.4, the damper 11 is externally protruded corresponding to the two sides and buckled below the positioning buckle 1.4 so as to have the damper 11 stably assembled into the movable cup seat 1; the top of one end of the damper 11 is leaned against the inner wall of the slot position 1.3 and the top of other end of the damper is leaned against the hinging arm 2 to buffer the opening force and closing force of the hinging arm 2.

Other unmentioned contents of this embodiment are as same as those in the first embodiment, which are not analyzed and illustrated here again.

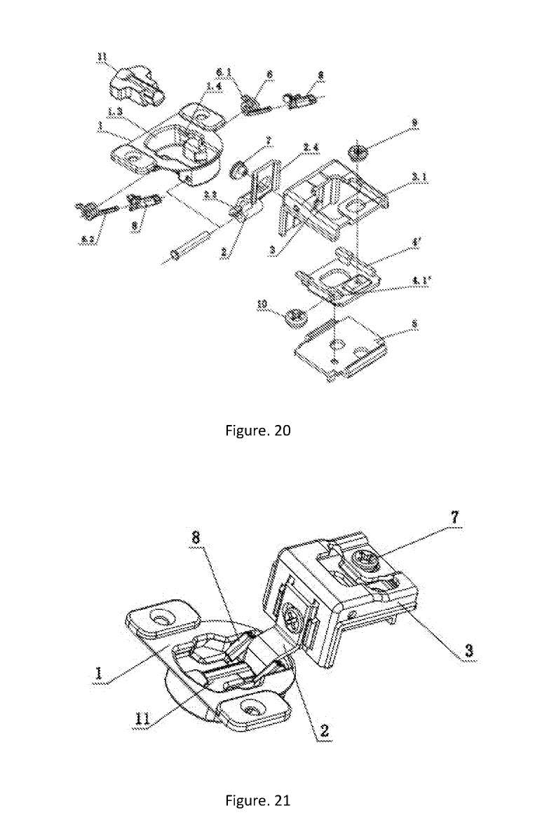

### The Fifth Embodiment (with Reference to FIG. 20 and FIG. 21)

The hinge used for furniture differs from the first embodiment in the following aspects: the structure comprises a movable cup seat 1, a hinging arm 2, an adjustable cover plate 3, a movable plate 4′ and a connecting plate 5, wherein the adjustable cover plate 3 is in sliding fit with the movable plate 4′ frontward and backward, the eccentric screw 9 passes through the capsule-shaped regulating hole 3.1 of the adjustable cover plate 3 to be screwed on the movable plate 4′; the movable plate 4′ is in sliding fit with the connecting plate 5 leftward and rightward, and the movable plate 4′ is provided with a capsule-shaped regulating hole 4.1′, the eccentric screw 10 passes through the capsule-shaped regulating hole 4.1′ to be screwed on the connecting plate 5; the connecting plate 5 is fixed on the furniture, the hinge is assembled on the furniture through the connecting plate 5; and the position of the hinge is adjusted by using tools to separately apply force on the eccentric screws 7, 9 and 10.

The slot position 1.3 is internally provided with a damper 11, the two sides on the inner wall of the slot position 1.3 are symmetrically provided with a positioning buckle 1.4, the damper 11 is externally protruded corresponding to the two sides and buckled below the positioning buckle 1.4 so as to have the damper 11 stably assembled into the movable cup seat 1; the top of one end of the damper 11 is leaned against the inner wall of the slot position 1.3 and the top of other end of the damper is leaned against the hinging arm 2 to buffer the opening force and closing force of the hinging arm 2.

Other unmentioned contents of this embodiment are as same as those in the first embodiment, which are not analyzed and illustrated here again.

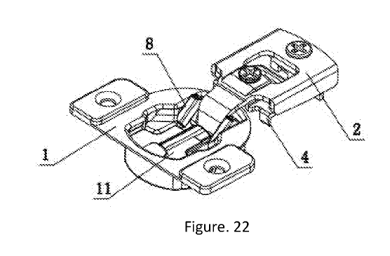

### The Sixth Embodiment (with Reference to FIG. 22)

The hinge used for furniture differs from the first embodiment in the following aspects: the structure is composed of a movable cup seat 1, a hinging arm 2 and a fixed part 4, wherein the hinging arm 2 is connected between the movable cup seat 1 and the fixed part 4, one end of the hinging arm 2 is hinged with the movable cup seat 1 and the other end of the hinging arm 2 is fixedly connected with the fixed part 4, and the fixed part 4 is fixed on the main body of furniture.

The slot position 1.3 is internally provided with a damper 11, the two sides on the inner wall of the slot position 1.3 are symmetrically provided with a positioning buckle 1.4, the damper 11 is externally protruded corresponding to the two sides and buckled below the positioning buckle 1.4 so as to have the damper 11 stably assembled into the movable cup seat 1; the top of one end of the damper 11 is leaned against the inner wall of the slot position 1.3 and the top of other end of the damper is leaned against the hinging arm 2 to buffer the opening force and closing force of the hinging arm 2.

Other unmentioned contents of this embodiment are as same as those in the first embodiment, which are not analyzed and illustrated here again.

What are illustrated above are just preferable embodiments of the present utility model, which exhibit and describe the fundamental principle, main features and the advantages of this utility model. Those skilled in the art shall understand that the present utility model will not be limited by the above-mentioned embodiments. What are described in the above-mentioned embodiments and the Description only explain the principle of the present utility model. The present utility model is intended to cover various modifications and improvements on the premise of not going beyond the spirit and scope of the present utility model, and these modifications and improvements should fall within the protection scope of the present utility model. The protection scope of the present utility model is defined by the attached claims and the equivalents thereof.

1. A hinge used for furniture, comprising a movable cup seat fixed on the furniture door body, an adjustable cover plate fixed on the furniture main body, a hinging arm connected between the movable cup seat and the adjustable cover plate as well as torsion springs configured to generate opening force or closing force at least on the movable cup seat, wherein two torsion springs are respectively arranged on the notches on both sides of the movable cup seat, characterized in that the torsion springs are provided with at least a first support leg linked to the protruded steps on both sides of the movable cup seat and a second support leg that extends into the movable cup seat capable of acting force on the hinging arm; the first support leg and/or the second support leg has a square-shaped section; the second support leg is provided with a torsion spring sleeve so that the second support leg is inserted into the corresponding sleeve holes; the torsion spring sleeve has a square outline, the bottom of which relatively moves along the arc-shaped stressed portion on the two sides of the hinging arm under the force applied by the torsion spring, thus generating opening force or closing force.

2. The hinge used for furniture according to claim 1, wherein the second support leg has a straightly-arranged square section, the sleeve holes are arranged in a manner of penetrating the torsion spring sleeve along the length direction, the section of the sleeve holes is squarely arranged corresponding to the second support leg, and the second support leg is correspondingly inserted into the sleeve holes.

3. The hinge used for furniture according to claim 2, wherein one end of torsion spring sleeve near the main body of the torsion springs is provided with an arc-shaped surface matching the main body surface of the torsion springs.

4. The hinge used for furniture according to claim 3, wherein one side of the arc-shaped surface is extended along the length direction and is provided with a protruded point, and the protruded point is inserted into the main body of the torsion springs.

5. The hinge used for furniture according to claim 4, wherein the parts of the torsion spring sleeve configured to insert into the second support leg are thickened.

6. The hinge used for furniture according to claim 5, wherein the end portion of the first support leg is bent and is reversely buckled into the steps.

7. The hinge used for furniture according to claim 6, wherein the movable cup seat is internally provided with a slot position, one end portion of the hinging arm is inserted into the slot position and is hinged with the movable cup seat through axis pins, the second support leg is inserted into the slot position and is configured to act on the stressed portion after passing through the side wall of the notches.

8. The hinge used for furniture according to claim 7, wherein the slot position is internally provided with a damper, one side or two sides on the inner wall of the slot position is/are provided with a positioning buckle, the corresponding one side or two sides of the damper is/are protruded externally and buckled below the positioning buckle, the top of one end of the damper is leaned against the inner wall of the slot position and the top of other end of the damper is leaned against the hinging arm to buffer the opening force and closing force of the hinging arm.

9. The hinge used for furniture according to claim 8, wherein the two sides of the other end portion of the hinging arm are provided with slide sheets, the adjustable cover plate is provided with a slide slot, the slide sheets can be freely inserted into the slide slot in a sliding manner, the hinging arm is capable of sliding freely with respect to the adjustable cover plate, the hinging arm is further provided with a capsule-shaped regulating hole, and an eccentric screw passes through the regulating hole to be screwed on the adjustable cover plate.

10. The hinge used for furniture according claim 1, wherein the torsion spring sleeve is formed by integrated plastic injection, and the two torsion springs are coaxially arranged with each other.
